(19) United States
(12) Patent Application Publication
(10) Pub. No.: US 2017/0021519 A1
(43) Pub. Date: Jan. 26, 2017

(54) PLANE CUTTING MACHINE FOR SOFT MATERIALS

(71) Applicant: GUANGDONG RUIZHOU TECHNOLOGY CO., LTD, Foshan (CN)

(72) Inventors: Ruizhou Guo, Foshan (CN); Huazhong Guo, Foshan (CN)

(21) Appl. No.: 15/003,901

(22) Filed: Jan. 22, 2016

(30) Foreign Application Priority Data
Jul. 24, 2015 (CN) 201510443883.8

(51) Int. Cl. B26D 7/06; D06C 29/00; B26F 1/38; B26D 1/45; B26D 3/10

(52) U.S. Cl. CPC B26D 7/0625; B26D 1/455; B26D 3/10; B26F 1/3813; D06C 29/00

(57) ABSTRACT

A plane cutting machine for soft materials may include a worktable, a feeding device, a XY plane cutting system, and a computer. The feeding device is located above the worktable. The XY plane cutting system is located above the feeding device. The worktable is divided into a first worktable and a second worktable. The feeding device comprises a first feeding device and a second feeding device disposed above the first worktable and the second worktable, respectively. A first camera and a second camera are provided above the first feeding device and the second feeding device, respectively. The first camera and the second camera are connected with an input end of the computer via a data line. The XY plane cutting system is connected with an output end of the computer via a data line.

### RELATED APPLICATIONS

The present application claims priority to Chinese Patent Application Serial No. 201510443883.8, which was filed Jul. 24, 2015, and is incorporated herein by reference in its entirety.

### TECHNICAL FIELD

The present disclosure relates to a plane cutting field, and more particularly to a plane cutting machine for soft materials.

### BACKGROUND

A plane cutting machine is widely used in the field of cardboard, fabric, leather and so on. Soft plane materials can be cut precisely by the plane cutting machine to achieve an automation production. A large-sized plane cutting machine is composed of a worktable, a XY plane cutting system, a conveyer, and a projector. The cutting steps of the large-sized plane cutting machine are as follows: 1. A conveyer delivers a soft plane material to the worktable, and then the operator flattens the soft plane material. 2. A cutter is used to cut the material according to the typesetting of the computer. 3. After cutting, the material is collected. 4. After collecting the material, the soft plane material is delivered to the worktable again. The aforesaid steps are repeatedly to complete all the cutting work of the soft plane material. This traditional way needs the operator to collect the finished product and the waste material after each cutting is completed, and then the soft plane material to be proceeded is delivered again. As a result, the production efficiency is low, particular to a large-sized soft plane material which is wide and long. After the material is delivered, the operator needs a lot of time to flatten the material. As a result, the production efficiency is very low. Besides, the computer is unable to identify the defect portion of the material. The cutting is performed blindly, so some of the finished products have defects to cause spoils. For a large-sized plane material, the spoils may influence the time of delivery. Accordingly, the inventor of the present disclosure has devoted himself based on his many years of practical experiences to solve these problems.

### SUMMARY

The present disclosure is to provide a high-efficiency and high-yield plane cutting machine for soft materials.

In order to achieve the aforesaid object, the plane cutting machine for soft materials includes a worktable, a feeding device, a XY plane cutting system, and a computer. The feeding device is located above the worktable. The XY plane cutting system is located above the feeding device. The worktable is divided into a first worktable and a second worktable. The feeding device includes a first feeding device and a second feeding device disposed above the first worktable and the second worktable, respectively. A first camera and a second camera are provided above the first feeding device and the second feeding device, respectively. The first camera and the second camera are connected with an input end of the computer via a data line. The XY plane cutting system is connected with an output end of the computer via a data line.

Preferably, the XY plane cutting system includes a first XY plane cutting system and a second XY plane cutting system.

Preferably, a first projector and a second projector are provided above the first feeding device and the second feeding device, respectively.

Preferably, two first projectors are provided and two second projectors are provided.

Preferably, the first projector, the second projector, the first camera, and the second camera are mounted above the first and second feeding devices through a support frame.

Preferably, the two first projectors are located at two sides of the first camera, and the two second projectors are located at two sides of the second camera.

Preferably, the first feeding device includes a first conveyer, a first drive roller, and a first driven roller.

Preferably, the second feeding device includes a second conveyer, a second drive roller, and a second driven roller.

Preferably, two support frames are provided and located at one side of the first worktable and one side of the second worktable, respectively. Each support frame includes an installation rod and an installation frame. One end of the installation rod is installed and fixed to each of the side of the first worktable and the side of the second worktable. Another end of the installation rod is hinged to the installation frame. The installation frame includes a hinge rod and an E-shaped frame. One end of the hinge rod is hinged to the installation rod. Another end of the hinge rod is hinged to a middle portion of the E-shaped frame. Each of the first camera and the second camera is installed to a free end of a middle rod of the E-shaped frame. The first projector and the second projector are installed to free ends of two side rods of the E-shaped frame.

The present disclosure is provided with two worktables, such that one worktable can proceed with the cutting work and another worktable can proceed with the work to receive and flatten the material to be proceeded. This way can enhance the work efficiency for cutting. Taking photos for the computer to analyze can avoid the defect area of the material so as to increase the rate of finished products. The rate of finished products is near 100%.

### BRIEF DESCRIPTION OF THE DRAWINGS

FIG. 1 is a perspective view of the present disclosure; and

FIG. 2 is a perspective view of the present disclosure, showing the finished product is cut.

### DETAILED DESCRIPTION

Embodiments of the present disclosure will now be described, by way of example only, with reference to the accompanying drawings.

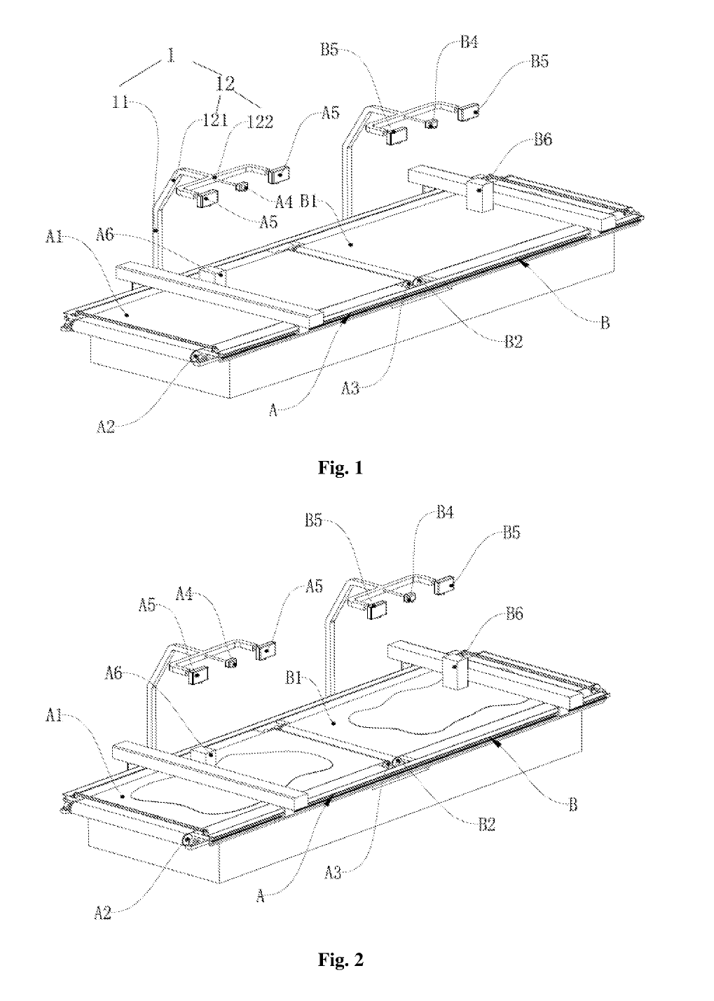

As shown in FIG. 1 and FIG. 2, the present disclosure discloses a plane cutting machine for soft materials. The plane cutting machine comprises two worktables, a first worktable A and a second worktable B. Each worktable is provided with a first conveyer A1 and a second conveyer B1. The first conveyer A1 is tightened and controlled by a first drive roller A2 and a first driven roller A3 to move back and forth. The second conveyer B1 is tightened and controlled by a second drive roller B2 and a second driven roller (not shown in the drawings) to move back and forth. A first camera A4, a second camera B4, a first projector A5, and a second projector B5 are provided above the working area. The first camera A4 and the second camera B4 are used to take photos for a computer to analyze images. The first projector A5 and the second projector B5 are used to project the typesetting images to the soft materials on the first conveyer A1 and the second conveyer B1 for the operator's preview. The plane cutting machine is provided with two XY plane cutting systems, a first XY plane cutting system A6 and a second XY plane cutting system B6. Each XY plane cutting system can control a cutter to move to a desired position of the working area.

The present disclosure is provided with two worktables, such that one worktable can proceed with the cutting work and another worktable can proceed with the work to collect and flatten the material to be proceeded. This way can enhance the work efficiency for cutting. Taking photos for the computer to analyze can avoid the defect area of the material so as to increase the rate of finished products. The rate of finished products is near 100%.

Preferably, the prevent disclosure is provided with two XY plane cutting systems, a first XY plane cutting system A6 and a second XY plane cutting system B6.

Preferably, the prevent disclosure is provided with a first feeding device and a second feeding device. The first projector A5 and the second projector B5 are provided above the first feeding device and the second feeding device, respectively.

The first worktable A and the second worktable B are separately provided with the first projector A5 and the second projector B5, which can save the time to adjust the positions of the projectors (the first projector A5 and the second projector B5) from time to time for convenient operations.

Preferably, two first projectors A5 are provided and two second projectors B5 are provided.

Preferably, the first projector A5, the second projector B5, the first camera A4, and the second camera B4 are mounted above the feeding devices through a support frame 1.

Using the support frame 1 for installation is quick and cost-effective.

Preferably, the two first projectors A5 are located at two sides of the first camera A4. The two second projectors B5 are located at two sides of the second camera B4.

This arrangement makes the projectors (the first projector A5 and the second projector B5) to proceed with a projection from both sides, such that the projecting effect is the best so as to enhance the precision of cutting.

Preferably, the first feeding device comprises the first conveyer A1, the first drive roller A2, and the first driven roller A3.

Preferably, the second feeding device comprises the second conveyer B1, the second drive roller B2, and the second driven roller.

Using the feeding device composed of the conveyer and the rollers is simple in structure and malfunctions less.

Preferably, two support frames 1 are provided. The two support frames 1 are located at one side of the first worktable A and one side of the second worktable B, respectively. Each support frame 1 comprises an installation rod 11 and an installation frame 12. One end of the installation rod 11 is installed and fixed to each of the side of the first worktable A and the side of the second worktable B. Another end of the installation rod 11 is hinged to the installation frame 12. The installation frame 12 comprises a hinge rod 121 and an E-shaped frame 122. One end of the hinge rod 121 is hinged to the installation rod 11. Another end of the hinge rod 121 is hinged to a middle portion of the E-shaped frame 122. Each of the first camera A4 and the second camera B4 is installed to a free end of a middle rod of the E-shaped frame 122. The first projector A5 and the second projector B5 are installed to free ends of two side rods of the E-shaped frame 122.

The support frame 1 is composed of the installation rod 11 and the installation frame 12. One end of the installation rod 11 is installed and fixed to the side of the worktable and another end of the installation rod 11 is hinged to the installation frame 12, such that the installation rod 11 can be adjusted according to the demand of work. The installation frame 12 comprises the hinge rod 121 and the E-shaped frame 122. One end of the hinge rod 121 is hinged to the installation rod 11 and another end of the hinge rod 121 is hinged to the middle portion of the E-shaped frame 122, such that the hinge rod 121 can be adjusted conveniently. The design of the E-shaped frame 122 is convenient for installation of the projectors (the first projector A5 and the second projector B5) and the cameras (the first camera A4 and the second camera B4).

The cutting process of the plane cutting machine is described hereinafter. First, the operator logins the background computer of the plane cutting machine via the internet to process the 3D design of the final product, such as shoes, bags, paper products, and so on. The facial materials of these products are soft materials, such as leather, paper, fabric, and so on. After that, the computer converts the 3D product into a 2D plane data, namely, the 3D product is unfolded in a 2D state. The computer gets the 2D data from the unfolded product for the follow-up plane cutting. After getting the 2D data, the computer performs the following procedures:

a) The surface of the soft material to be cut is checked. The defect portion is marked with a geometrical pattern. The soft material is flattened on the first worktable A.

b) The soft material lying on the first worktable A is photoed. The computer analyzes the photo.

c) The computer commands the XY plane cutting system to cut the soft material on the first worktable A according to the pattern typesetting by the computer. The computer controls the XY plane cutting system to avoid the defect portion when cutting.

d) After the first worktable A completes the cutting procedure, the finished product on the worktable A is collected and the waste material is recycled.

During the aforesaid steps, when the step c is performed, another soft material to be cut is placed and flattened on the second worktable B; when the step d is performed, the soft material lying on the first worktable B is photoed; when the step a is performed, the computer commands the XY plane cutting system to cut the soft material on the first worktable B according to the pattern typesetting by the computer, and the computer controls the XY plane cutting system to avoid the defect portion when cutting; when the step b is performed, the finished product on the worktable B is collected and the waste material is recycled.

After the aforesaid steps are completed, the name, telephone, address and the like of the receiver are printed by the computer, and then the product is mailed to the client.

Through the cutting method of the plane cutting machine, the cutting work can be performed ceaselessly. In particular, for a large-sized plane product, it needs much time to flatten the wrinkled large-sized soft material on the conveyer. By using this cutting method, when the cutting is performed at one area, the operator has enough time to flatten the material before cutting at another area. This achieves ceaseless cutting to increase production efficiency. The flattened material is photoed for analysis, so that the computer can identify the defect on the surface of the soft material. When cutting, the defect portion can be avoided to increase the rate of finished products. This cutting method needs only one operator to perform the job of two worktables so as to save labor.

The defect portion of the soft material is marked with a geometrical pattern, such as a square, a triangle, a circle and so on for the computer to identify the defect conveniently.

The operator can elect one or two XY plane cutting systems for cutting, depending on the workload. If the workload is small, for example, only one pattern needs to be cut, one XY plane cutting system is used for cutting. If the workload is big, for example, many patterns need to be cut, two XY plane cutting systems are used for cutting so as to increase the cutting efficiency. When two XY plane cutting systems are used for cutting at the same working area simultaneously, the computer can control the two XY plane cutting systems not to interfere with each other.

Although particular embodiments of the present disclosure have been described in detail for purposes of illustration, various modifications and enhancements may be made without departing from the spirit and scope of the present disclosure. Accordingly, the present disclosure is not to be limited except as by the appended claims.

What is claimed is:

1. A plane cutting machine for soft materials, comprising a worktable, a feeding device, a XY plane cutting system and a computer, the feeding device being located above the worktable, the XY plane cutting system being located above the feeding device, the worktable being divided into a first worktable and a second worktable, the feeding device comprising a first feeding device and a second feeding device disposed above the first worktable and the second worktable respectively, a first camera and a second camera being provided above the first feeding device and the second feeding device respectively; the first camera and the second camera being connected with an input end of the computer via a data line; the XY plane cutting system being connected with an output end of the computer via a data line.

2. The plane cutting machine for soft materials as claimed in claim 1, wherein the XY plane cutting system comprises a first XY plane cutting system and a second XY plane cutting system.

3. The plane cutting machine for soft materials as claimed in claim 2, wherein a first projector and a second projector are provided above the first feeding device and the second feeding device, respectively.

4. The plane cutting machine for soft materials as claimed in claim 3, wherein two first projectors are provided and two second projectors are provided.

5. The plane cutting machine for soft materials as claimed in claim 4, wherein the first projector, the second projector, the first camera, and the second camera are mounted above the first and second feeding devices through a support frame.

6. The plane cutting machine for soft materials as claimed in claim 5, wherein the two first projectors are located at two sides of the first camera, and the two second projectors are located at two sides of the second camera.

7. The plane cutting machine for soft materials as claimed in claim 6, wherein the first feeding device comprises a first conveyer, a first drive roller, and a first driven roller.

8. The plane cutting machine for soft materials as claimed in claim 7, wherein the second feeding device comprises a second conveyer, a second drive roller, and a second driven roller.

9. The plane cutting machine for soft materials as claimed in claim 8, wherein two support frames are provided and located at one side of the first worktable and one side of the second worktable respectively; each support frame comprises an installation rod and an installation frame; one end of the installation rod is installed and fixed to each of the side of the first worktable and the side of the second worktable; another end of the installation rod being hinged to the installation frame; the installation frame comprises a hinge rod and an E-shaped frame; one end of the hinge rod is hinged to the installation rod; another end of the hinge rod is hinged to a middle portion of the E-shaped frame; each of the first camera and the second camera is installed to a free end of a middle rod of the E-shaped frame; the first projector and the second projector are installed to free ends of two side rods of the E-shaped frame.
